(19) United States
(12) Patent Application Publication
(10) Pub. No.: US 2006/0074885 A1
(43) Pub. Date: Apr. 6, 2006

(54) Keyword prefix/suffix indexed data retrieval

(75) Inventors: Chaucer Chiu, Taipei (TW); Jenny Xu, Taiwan (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 10/993,695

(22) Filed: Nov. 19, 2004

(30) Foreign Application Priority Data
Oct. 1, 2004 (TW) 093129798

(51) Int. Cl. G06F 17/30

(52) U.S. Cl. 707/3

(57) ABSTRACT

A keyword prefix/suffix indexed data retrieval method and system is proposed, which is designed for use in conjunction with a computer platform for providing a keyword prefix/suffix indexed data retrieval function that can respond to a user-input keyword of a phonetic language, such as English, and utilize the prefix/suffix part and stem part of the keyword to search in a database, such as an English-Chinese dictionary database, for the keyword's corresponding data item in the database, such as the Chinese definition and related data of the input English word. The proposed data retrieval method and system is advantageous in that it can help reduce the number of comparisons between the keyword and the indexes, so that the retrieval of the user-requested data item can be made more efficiently.

### BACKGROUND OF THE INVENTION

1. Field of the Invention

This invention relates to information technology (IT), and more particularly, to a keyword prefix/suffix indexed data retrieval method and system which is designed for use in conjunction with a computer platform, such as a desktop computer, a notebook computer, a tablet computer, a PDA (Personal Digital Assistant), an electronic dictionary, or the like, for providing a keyword prefix/suffix indexed data retrieval function that can respond to a user-input keyword of a phonetic language, such as English, and utilize the prefix/suffix part and stem part of the keyword to search in a database, such as an online English-Chinese dictionary database, for the keyword's corresponding data item in the database, such as the Chinese definition and related data of the input English word.

2. Description of Related Art

Online dictionary, such as online English-Chinese dictionary, is a popular computer application which is installed to a computer platform, such as a desktop PC (personal computer), a notebook PC, a tablet PC, a PDA (Personal Digital Assistant), a dedicated electronic dictionary device, or the like, and which allows the user to input a word of a natural language, such as English, as keyword to retrieve the corresponding definition and related data (such as pronunciations, etymologies, usage guide, etc.) in another language, such as Chinese. Since online dictionaries allow users to more quickly find the definition and related data of unfamiliar words in a foreign language, it is far more advantageous to use in the learning of foreign languages than traditional printed dictionaries.

Presently, in the use of online English-Chinese dictionaries, the user needs first to input the text string of the English word, and then the input text string is used as keyword to search through a dictionary database for the corresponding data item (i.e., the Chinese definition and related data of the input English word).

One drawback to the conventional keyword-indexed data retrieval method, however, is that the entire text string of the keyword needs to be compared against all the indexes of the dictionary database for mapping to the desired data item, and as a result, the lookup procedure is quite time-consuming and thus very inefficient.

### SUMMARY OF THE INVENTION

It is therefore an objective of this invention to provide a keyword prefix/suffix indexed data retrieval method and system which can be used in conjunction with an online English-Chinese dictionary to enhance the lookup speed so as to allow the retrieval of the user-requested data item more efficiently.

The keyword prefix/suffix indexed data retrieval method and system according to the invention is designed for use in conjunction with a computer platform, such as a desktop computer, a notebook computer, a tablet computer, a PDA (Personal Digital Assistant), an electronic dictionary, or the like, for providing a keyword prefix/suffix indexed data retrieval function that can respond to a user-input keyword of a phonetic language, such as English, and utilize the prefix/suffix and stem of the keyword to search in a database, such as an English-Chinese dictionary database, for the keyword's corresponding data item in the database, such as the Chinese definition of the input English keyword.

The keyword prefix/suffix indexed data retrieval method and system according to the invention is advantageous in that it can help reduce the number of comparisons between the keyword and the indexes, so that the retrieval of the user-requested data item can be made more efficiently.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing the application architecture and object-oriented component model of the keyword prefix/suffix indexed data retrieval system according to the invention; and

FIG. 2 is a schematic diagram showing an example of the data structure of a database module, a prefix/suffix listing module, and a stem listing module utilized by the keyword prefix/suffix indexed data retrieval system of the invention.

### DETAILED DESCRIPTION OF PREFERRED EMBODIMENTS

The keyword prefix/suffix indexed data retrieval method and system according to the invention is disclosed in full details by way of preferred embodiments in the following with reference to the accompanying drawings.

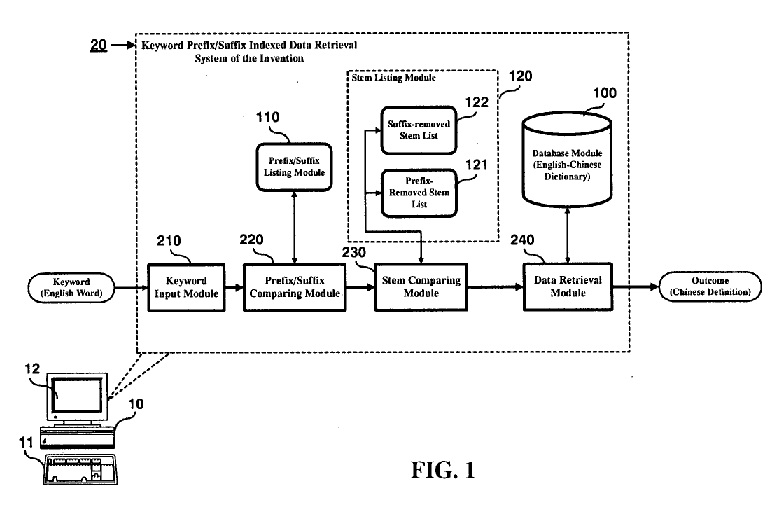

FIG. 1 is a schematic diagram showing the application architecture and object-oriented component model of the keyword prefix/suffix indexed data retrieval system according to the invention (as the part enclosed in the dotted box indicated by the reference numeral 20). As shown, the keyword prefix/suffix indexed data retrieval system of the invention 20 is designed for use with in conjunction with a computer platform 10, such as a desktop computer, a notebook computer, a tablet computer, a PDA (Personal Digital Assistant) unit, a dedicated electronic dictionary device, or the like, for providing a keyword prefix/suffix indexed data retrieval function that can respond to a user-input keyword of a phonetic language, such as an English word, and utilize the prefix/suffix and stem of the input keyword to search in a database (such as an English-Chinese dictionary database) for the keyword's corresponding data item in the database (such as the Chinese definition and related data of the input English word).

For example, in the application of online English-Chinese dictionary, if the user wants to use the computer platform 10 to look up the English word [misadvice] for its Chinese definition, then user needs just to input the text string of [misadvice] through the keyboard 11, and the keyword prefix/suffix indexed data retrieval system of the invention 20 will be activated to utilize the prefix part [mis-] and the stem part [advice] of the keyword [misadvice] to retrieve the corresponding data item (i.e., the Chinese definition of the English word [misadvice]) from the online English-Chinese dictionary and display the retrieved data on the screen 12. Similarly, if the user wants to look up the English word [childish] for its Chinese definition, the user needs just to input the text string of [childish], and the keyword prefix/suffix indexed data retrieval system of the invention 20 will be activated to utilize the suffix part [-ish] and the stem part [child] of the keyword [childish] to retrieve the corresponding data item from the online English-Chinese dictionary and display the retrieved data on the screen 12.

In practical implementation, the keyword prefix/suffix indexed data retrieval system of the invention 20 can be fully realized by software and installed to the computer platform 10. The software architecture of the keyword prefix/suffix indexed data retrieval system of the invention 20 is shown in FIG. 1.

As shown in FIG. 1, the object-oriented component model of the keyword prefix/suffix indexed data retrieval system of the invention 20 comprises: (a) a database module 100; (b) a prefix/suffix listing module 110; (c) a stem listing module 120; (d) a keyword input module 210; (e) a prefix/suffix comparing module 220; (f) a stem comparing module 230; and (g) a data retrieval module 240.

The database module 100 is for example an English-Chinese dictionary database, which prestores a number of data items (such as the Chinese definition and related data of each word in a selected English vocabulary set), and wherein each data item is mapped to an English word.

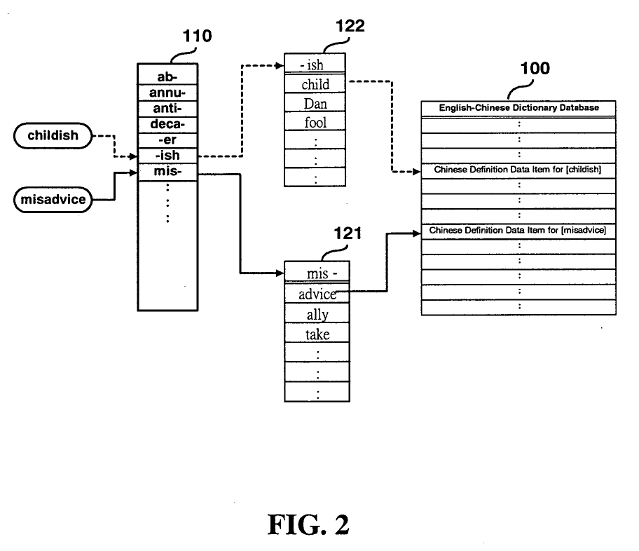

The prefix/suffix listing module 110 is used to prestore a list of prefixes and suffixes of all the words in a selected vocabulary set of a phonetic language, such as English. For example, as shown in FIG. 2, in the application of online English-Chinese dictionary, the prefix/suffix listing module 110 is used to store a set of English prefixes and suffixes such as [ab-], [annu-], [anti-], [deca-], [-er], [-ish], [mis-], to name just a few.

The stem listing module 120 is used to store a number of lists of prefix-removed stems 121 and a number of lists of suffix-removed stems 122 for all the words in the selected vocabulary set of English; wherein each prefix-removed stem list 121 corresponds to one prefix in the above-mentioned prefix/suffix listing module 110 and is used to store the prefix-removed stem of each English word in the selected vocabulary set that has the corresponded prefix, whereas each suffix-removed stem list 122 corresponds to one suffix in the above-mentioned prefix/suffix listing module 110 and is used to store the suffix-removed stem of each English word in the selected vocabulary set that has the corresponded suffix. Further, all the stems in this stem listing module 120 are predefined to be mapped in one-to-one correspondence to the data items in the database module 100. For example, as shown in FIG. 2, in the application of online English-Chinese dictionary, the prefix-removed stem list 121 in the stem listing module 120 that corresponds to the prefix [mis-] includes a set of stems as [advice], [ally], and [take], which are respectively derived from the English words [misadvice], [misally], and [mistake] by removing the prefix [mis-] thereof; and one of the prefix-removed stem lists 121 in the stem listing module 120 that corresponds to the prefix [mis-] includes a set of stems as [advice], [ally], and [take], which are respectively derived from the English words [misadvice], [misally], and [mistake] by removing the prefix [mis-] thereof; and the suffix-removed stem list 122 in the stem listing module 120 that corresponds to the suffix [-ish] includes a set of stems as [child], [Dan], and [fool], which are respectively derived from the English words [childish], [Danish], and [foolish] by removing the suffix [-ish] thereof.

The keyword input module 210 is a user-operable input module which is capable of receiving a user-input text string via the keyboard 11, such as an English word, and using the user-input text string as a keyword.

The prefix/suffix comparing module 220 is capable of comparing each of the prefixes and suffixes in the above-mentioned prefix/suffix listing module 110 against the prefix and suffix part of the user-input keyword received by the keyword input module 210; and if either the prefix or the suffix part of the user-input keyword is matched, the prefix/suffix comparing module 220 will issue a stem-comparison enabling message to the stem comparing module 230.

The stem comparing module 230 is capable of being activated in response to the stem-comparison enabling message from the above-mentioned prefix/suffix comparing module 220 to compare each stem in the corresponding prefix-removed stem list 121 or suffix-removed stem list 122 in the stem listing module 120 against the stem that is resulted from the removal of the matched prefix or suffix from the keyword. More specifically speaking, if the user-input keyword is a prefix-matched, then the prefix part of the keyword is removed, and the remaining stem part is compared against the corresponding prefix-removed stem list 121 in the stem listing module 120 to find a matched stem therein; and whereas if the user-input keyword is a suffix-matched, then the suffix part of the keyword is removed, and the remaining stem part is compared against the corresponding suffix-removed stem list 122 in the stem listing module 120 to find a matched stem therein. If a matched stem is found, the stem comparing module 230 will issue a data retrieval requesting message to the data retrieval module 240.

The data retrieval module 240 is capable of being activated in response to the data retrieval requesting message from the above-mentioned stem comparing module 230 to retrieve the data item that corresponds to the matched stem from the database module 100.

Referring to FIG. 1 together with FIG. 2, in the following example of practical application, it is assumed that the user wants to look up the English words [misadvice] and [childish] from an online English-Chinese dictionary that utilizes the keyword prefix/suffix indexed data retrieval system of the invention 20.

In the case that the user wants to look up for the Chinese definition of the English word [misadvice] in the online English-Chinese dictionary, the user needs first to activate the keyword prefix/suffix indexed data retrieval system of the invention 20 and use the keyword input module 210 to input the text string of [misadvice] as keyword. This action causes the prefix/suffix comparing module 220 to compare each of the prefixes and suffixes in the prefix/suffix listing module 110 against the prefix and suffix part of the keyword [misadvice] to find if either the prefix or the suffix part of the keyword [misadvice] is matched to any one of the prefixes and suffixes in the prefix/suffix listing module 110. In the example of FIG. 2, the prefix [mis-] in the prefix/suffix listing module 110 is matched to the prefix part of the keyword [misadvice], and therefore it causes the prefix/suffix comparing module 220 to issue a stem-comparison enabling message to the stem comparing module 230. In response, the stem comparing module 230 is activated to compare each stem in the corresponding prefix-removed stem list 121 in the stem listing module 120 against the stem part [advice] of the keyword [misadvice] that is resulted from the removal of the matched prefix [mis-]. When a match is found, the stem comparing module 230 issues a data retrieval requesting message to the data retrieval module 240, causing the data retrieval module 240 to retrieve the data item that corresponds to the matched stem [advice] from the database module 100, and displays the retrieved data item (i.e., the Chinese definition and usage guide of the English word [misadvice], on the screen 12 of the computer platform 10.

Similarly, in the case that the user wants to look up for the Chinese definition of the English word [childish], the user needs first to use the keyword input module 210 to input the text string of [childish] as keyword. This action causes the prefix/suffix comparing module 220 to compare each of the prefixes and suffixes in the prefix/suffix listing module 110 against the prefix and suffix part of the keyword [misadvice] to find if either the prefix or the suffix part of the keyword [childish] is matched to any one of the prefixes and suffixes in the prefix/suffix listing module 110. In the example of FIG. 2, the suffix [-ish] in the prefix/suffix listing module 110 is matched to the suffix part of the keyword [childish], and therefore it causes the prefix/suffix comparing module 220 to issue a stem-comparison enabling message to the stem comparing module 230. In response, the stem comparing module 230 is activated to compare each stem in the corresponding suffix-removed stem list 122 in the stem listing module 120 against the stem part [child] of the keyword [childish] that is resulted from the removal of the matched suffix [-ish]. When a match is found, the stem comparing module 230 issues a data retrieval requesting message to the data retrieval module 240, causing the data retrieval module 240 to retrieve the data item that corresponds to the matched stem [child] from the database module 100, and displays the retrieved data item (i.e., the Chinese definition and usage guide of the English word [childish], on the screen 12 of the computer platform 10.

In conclusion, the invention provides a keyword prefix/suffix indexed data retrieval method and system which is designed for use in conjunction with a computer platform for providing a keyword prefix/suffix indexed data retrieval function that can respond to a user-input keyword of a phonetic language, such as English, and utilize the prefix/suffix and stem of the keyword to search in a database, such as an English-Chinese dictionary database, for the keyword's corresponding data item in the database, such as the Chinese definition of the input English keyword. The keyword prefix/suffix indexed data retrieval method and system according to the invention is advantageous in that it can help reduce the number of comparisons between the keyword and the indexes, so that the retrieval of the user-requested data item can be made more efficiently. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A keyword prefix/suffix indexed data retrieval method for use on a computer platform for providing a keyword prefix/suffix indexed data retrieval function;
the keyword prefix/suffix indexed data retrieval method comprising;
building a database module, which prestores a number of data items, wherein each data item is mapped to a word in a selected vocabulary set of a particular language;
building a prefix/suffix listing module, which prestores a list of prefixes and suffixes of all the words in the selected vocabulary set;
building a stem listing module, which prestores a number of lists of prefix-removed stems and number of lists of suffix-removed stems of all the words in the selected vocabulary set; wherein each list of prefix-removed stems corresponds to one prefix in the prefix/suffix listing module and is used to store the prefix-removed stem of each word in the selected vocabulary set that has the corresponded prefix, while each list of suffix-removed stems corresponds to one suffix in the prefix/suffix listing module and is used to store the suffix-removed stem of each word in the selected vocabulary set that has the corresponded suffix; and wherein all the stems in the stem listing module are predefined to be mapped in one-to-one correspondence to all the data items in the database module;
and in actual use,
receiving a user-input keyword;
comparing each of the prefixes and suffixes in the prefix/suffix listing module against the prefix/suffix part of the user-input keyword;
if either the prefix part or the suffix part of the user-input keyword is matched, comparing each stem in the stem listing module against the stem that is resulted from the removal of the matched prefix or suffix from the keyword; and
if a match of stem is found, retrieving the data item from the database module that is mapped to the matched stem.

2. The keyword prefix/suffix indexed data retrieval method of claim 1, wherein the computer platform is a desktop computer.

3. The keyword prefix/suffix indexed data retrieval method of claim 1, wherein the computer platform is a notebook computer.

4. The keyword prefix/suffix indexed data retrieval method of claim 1, wherein the computer platform is a tablet computer.

5. The keyword prefix/suffix indexed data retrieval method of claim 1, wherein the computer platform is a PDA (Personal Digital Assistant) unit.

6. The keyword prefix/suffix indexed data retrieval method of claim 1, wherein the computer platform is an electronic dictionary device.

7. A keyword prefix/suffix indexed data retrieval system for use with a computer platform for providing a keyword prefix/suffix indexed data retrieval function;
the keyword prefix/suffix indexed data retrieval system comprising:
a database module, which prestores a number of data items, wherein each data item is mapped to a word in a selected vocabulary set of a particular language;
a prefix/suffix listing module, which prestores a list of prefixes and suffixes of all the words in the selected vocabulary set;
a stem listing module, which prestores a number of lists of prefix-removed stems and number of lists of suffix-removed stems of all the words in the selected vocabulary set; wherein each list of prefix-removed stems corresponds to one prefix in the prefix/suffix listing module and is used to store the prefix-removed stem of each word in the selected vocabulary set that has the corresponded prefix, while each list of suffix-removed stems corresponds to one suffix in the prefix/suffix listing module and is used to store the suffix-removed stem of each word in the selected vocabulary set that has the corresponded suffix; and wherein all the stems in the stem listing module are predefined to be mapped in one-to-one correspondence to all the data items in the database module;
a keyword input module, which is a user-operable data input module used to receive a user-input keyword;
a prefix/suffix comparing module, which is capable of comparing each of the prefixes and suffixes in the prefix/suffix listing module against the prefix/suffix part of the user-input keyword, and which is capable of issuing a stem-comparison enabling message if either the prefix part or the suffix part of the user-input keyword is matched;
a stem comparing module, which is capable of being activated in response to the stem-comparison enabling message from the prefix/suffix comparing module to compare each stem in the stem listing module against the stem that is resulted from the removal of the matched prefix or suffix from the keyword, and which is capable of issuing a data retrieval requesting message if a match is found; and
a data retrieval module, which is capable of being activated in response to the data retrieval requesting message from the stem comparing module to retrieve the data item that is mapped to the matched stem.

8. The keyword prefix/suffix indexed data retrieval system of claim 7, wherein the computer platform is a desktop computer.

9. The keyword prefix/suffix indexed data retrieval system of claim 7, wherein the computer platform is a notebook computer.

10. The keyword prefix/suffix indexed data retrieval system of claim 7, wherein the computer platform is a tablet computer.

11. The keyword prefix/suffix indexed data retrieval system of claim 7, wherein the computer platform is a PDA (Personal Digital Assistant) unit.

12. The keyword prefix/suffix indexed data retrieval system of claim 7, wherein the computer platform is an electronic dictionary device.
